(19) United States
(12) Patent Application Publication
(10) Pub. No.: US 2024/0301716 A1
(43) Pub. Date: Sep. 12, 2024

(54) SYSTEM FOR PARTIALLY FILLING AN ENCLOSURE

(71) Applicant: Georgia Tech Research Corporation, Atlanta, GA (US)

(72) Inventors: Francisco Valdes Castillo, Atlanta, GA (US); Alexander Samoylov, Atlanta, GA (US)

(21) Appl. No.: 18/596,483

(22) Filed: Mar. 5, 2024

Related U.S. Application Data
(60) Provisional application No. 63/450,271, filed on Mar. 6, 2023.

(51) Int. Cl. E04H 15/20; A01K 1/00; E04H 15/12

(52) U.S. Cl. CPC E04H 15/20; A01K 1/0035; E04H 15/12

(57) ABSTRACT

Systems for filling a portion of an interior of an enclosure are disclosed. The systems include a bladder that is flexible. The bladder defines an interior that is configured to retain a fluid. The bladder includes an inlet that can fluidly connect the interior of the bladder to an external environment surrounding the bladder. The bladder can be inflated within the interior of the enclosure by the fluid from a deflated configuration to an inflated configuration to fill the portion of the interior of the enclosure.

### CROSS REFERENCE TO RELATED APPLICATIONS

This application claims priority to U.S. Provisional Patent Application No. 63/450,271, filed on Mar. 6, 2023, the entirety of which is hereby incorporated herein by reference.

### TECHNICAL FIELD

This disclosure is generally directed to the field of pneumatic structures, and more particularly to systems for partially filling an enclosure with a pneumatic structure.

### BACKGROUND

Pneumatic structures can offer cost-effective and flexible alternatives to traditional structures. Pneumatic structures can be lightweight and portable, which can be ideal for use in remote locations. Pneumatic structures can be rapidly deployed, rapidly dismantled, and can offer a safe and secure environment, such as, for disaster relief efforts to create temporary shelters and medical facilities. Pneumatic structures can be customized to meet specific requirements and can be more cost-effective and flexible than traditional structures. Pneumatic structures can be climate controlled. Pneumatic structures can be used for a variety of applications across various industries such as, for example, to create spaces for exhibition halls, trade shows, sports events (e.g., for indoor tennis courts, golf practice facilities, and ice rinks), for military use (e.g., to create field hospitals, command centers, and temporary barracks), for industrial use (e.g., such as for storage, manufacturing, and warehousing), among other possibilities.

### SUMMARY

The inventors recognized that climate control for pneumatic structures can be energy intensive, expensive, and wasteful. These short coming are addressed, to a great extent, by a system for filling a portion of an interior of an enclosure according to some aspects of the invention. The system includes a bladder that is flexible. The bladder defines an interior that is configured to retain a fluid. The bladder may include an inlet that is configured to fluidly connect the interior of the bladder to an external environment surrounding the bladder. The bladder is configured to be inflated, within the interior of the enclosure, by the fluid from a deflated configuration to an inflated configuration to fill the portion of the interior of the enclosure.

Implementations may include one or more of the following features. The system may include a pump fluidly connected to the inlet. The pump is configured to pump the fluid from the external environment and through the inlet of the bladder to inflate the interior of the bladder. The system may include a controller that is operatively connected to the pump and that is configured to control the pump to fill the bladder with the fluid. The system may include a sensor that is configured to sense a pressure within the interior of the bladder. The controller is operatively connected to the sensor and is configured to automatically control the pump to maintain a predetermined pressure within the interior of the bladder based upon feedback of the pressure sensed by the sensor. The system may include a temperature regulator that is fluidly connected to the pump and that is configured to at least one of heat or cool the fluid pumped by the pump. The controller is operatively connected to the sensor and to the temperature regulator, and the controller is configured to automatically control the temperature regulator to maintain a predetermined temperature within the interior of the bladder based upon feedback of the temperature sensed by the sensor. The system may include the enclosure. The portion of the interior of the enclosure defines a first shape and a first size. The bladder in the inflated configuration defines a second shape and a second size. The second shape substantially corresponds to the first shape and the second size is smaller than the first size. The enclosure may include a vent that is configured to vent a gas from the interior of the enclosure. The system may include a fan that actively vents the gas from the interior of the enclosure through the vent. The enclosure is configured to contain livestock. The portion of the interior of the enclosure is between 40% and 60% of a volume of the interior of the enclosure. The bladder is substantially fluid-tight to resist leaking of the fluid from the interior of the bladder. The fluid is air. The fluid may include a gas that is the same as a gas that fills the interior of the enclosure surrounding the bladder. The fluid may include a gas that is different than a gas that fills the interior of the enclosure surrounding the bladder. The bladder may include at least one of nylon, fiberglass polyester, or silicon. The bladder may include a coating. The coating may include at least one of polyester, PVC, or vinyl. A surface of the bladder that faces a floor of the enclosure, when the bladder is in the inflated configuration within the interior of the enclosure, may include first contours and second contours. The first contours are spaced from the floor by a first distance and the second contours are spaced from the floor by a second distance, the second distance is greater than the first distance.

Various additional features and advantages of this invention will become apparent to those of ordinary skill in the art upon review of the following detailed description of the illustrative embodiments taken in conjunction with the accompanying drawings.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 shows a view of an example system with a bladder in an inflated configuration.

FIG. 2 shows a view of the system with the bladder in the deflated configuration.

### DETAILED DESCRIPTION

Aspects of the present invention are directed towards systems for partially filling the interior of an enclosure. The system can include a bladder that is flexible. The bladder can define an interior that can retain a fluid. The bladder can include an inlet that can fluidly connect the interior of the bladder to an external environment indirectly or directly surrounding the bladder. The bladder can be inflated with the fluid within the interior of the enclosure from a deflated configuration to an inflated configuration to fill the portion of the interior of the enclosure.

In embodiments, the enclosure can be a pneumatic structure, though the system can be used with any number other structures including traditional fixed structures like warehouses, auditoriums, among other possibilities. In one example, the systems can be used for with livestock houses (e.g., for broiler chickens, ducks, turkeys, among other possibilities) and the bladder can displace a certain volume of air inside the broiler house to reduce the need for air conditioning and ventilation. The term “livestock” as used throughout this disclosure can include the plain and ordinary meaning and can at least include broiler chickens.

The systems can be quickly deployable and retractable and can be adjusted to different volumes to adapt to the changing requirements of the enclosure. For example, during a typical growth cycle for the livestock within the enclosure, the bladder can be fully inflated to provide an optimal environment for livestock growth and can maintain consistent temperature and humidity levels throughout the growth cycle. During maintenance tasks or harvesting, the bladder can be deflated and retracted to allow for people and/or equipment to move through the poultry house.

The systems of this disclosure can promote efficient air exchange and provide easy access for operators throughout the enclosure (e.g., poultry house). In addition, the systems can offer functionalities as a ventilation management tool to help regulate temperature, humidity, and air quality, and further reduce the need for heating and cooling.

The shape and design of the systems of this disclosure can optimize livestock well-being and can provide a more natural environment for livestock growth. For example, a shape of the inflated bladder can be optimized using (e.g., via Computational Fluid Dynamics (CFD)) to fill a predetermined volume of a particular enclosure when inflated. For example, the shape of the inflated bladder can be analyzed and optimized to achieve targeted airflow and ventilation throughout the enclosure (e.g., poultry house). This analysis can help to identify areas of potential turbulence or stagnation in the airflow, which can be adjusted to improve overall efficiency and ventilation. Optimizing the shape of the inflated bladder can have a number of benefits for livestock growth and welfare. For example, it can help to reduce the occurrence of hot spots or cold spots in the poultry house, which can lead to uneven growth rates and other health issues. Furthermore, it can help to reduce the risk of respiratory diseases in the livestock within the enclosure, which can be an issue in conventional poultry houses. Improved ventilation can help to remove moisture, ammonia, and other pollutants from the air, which can create a more comfortable and healthier environment for the birds.

The bladder can include a pattern or shape that is reflective of a natural environment, further enhancing livestock well-being. For example, broiler chickens, like all animals, can have specific requirements for their environment to promote their well-being and health. Broiler chickens can have a natural inclination to seek out canopies or structures for shelter, and the use of canopies (e.g., formed by contours in the bladder) or structures in poultry houses can have benefits for animal welfare and productivity. Canopies or structures formed by the bladder can help to regulate the temperature and humidity levels in the poultry house, creating a more comfortable environment for the birds. This can lead to improved growth rates, feed conversion, and overall bird health and welfare.

In addition, the systems of this disclosure can include attachments for livestock feeders and drinkers, minimizing the impact on existing livestock operations and providing a more efficient use of space. In embodiments, the shape of the bladder can also include shapes (e.g., defined by contours) that can facilitate operator passages to different locations below the bladder throughout the house.

The inflatable structure (e.g., bladder) can be made from high-strength, lightweight fabric materials such as PVC-coated polyester or nylon and can be reinforced with a frame made from aluminum or steel. The interior of the bladder can be inflated, for example, to pressures between 2 and 8 PSI, though other pressure ranges outside this range are possible. The bladder, when inflated, can displace a volume within the interior of the enclosure, which can significantly improve energy savings directed to maintaining the climate within such enclosures. For example, the bladder, when inflated, can displace within a range of between 40% and 60% of the volume within the interior of the enclosure, though in embodiments the bladder can displace other volumes outside of this range as well. Aspects of this disclosure can include a bladder with an air-tight volume that can be accompanied with particular insulating materials and/or special insulating gases that can help reduce heat loss in the winter and heat gain in the summer, which can lower heating and cooling costs.

Aspects of the system for filling the interior of the enclosure can be constructed using specialized manufacturing techniques such as heat welding and/or sewing and can be tested to ensure that it can withstand the necessary internal pressures. The specific design of the system can vary depending on the size and requirements of the enclosure. According to aspects of this invention, the systems for filling a portion of the interior of the enclosure can improve energy efficiency, promote the livestock well-being, reduce energy consumption and costs for poultry growers, and can provide an optimal environment for broiler growth.

For example, the systems of this disclosure can save significant amounts of energy and reduce costs associated with energy use. For example, although energy consumption for heating and ventilation can vary depending on several factors, including the location, climate, building design, and management practices; the total energy consumption for a broiler house can be estimated to be approximately 70 k Wh per square meter per year. Therefore, the total energy consumption for HVAC in a 1000 square meter broiler house can roughly calculated as:
Total HVAC energy consumption=70 kWh/sq·m/year×1000 sq·m=70,000 kWh/year Assuming a maximum cost of energy of $0.20/k Wh, the total cost per year for HVAC energy consumption can estimated to be:
Total HVAC cost=70,000 kWh/year×$0.20/kWh=$14,000/year

Depending on the size of the enclosure, the system for filling a portion of an interior of an enclosure of aspects of this invention can displace 450,000 liters of air volume, resulting in energy savings of around 60%, for example. Those energy savings are achieved by reducing the need for air conditioning and ventilation, resulting in lower energy consumption and costs.

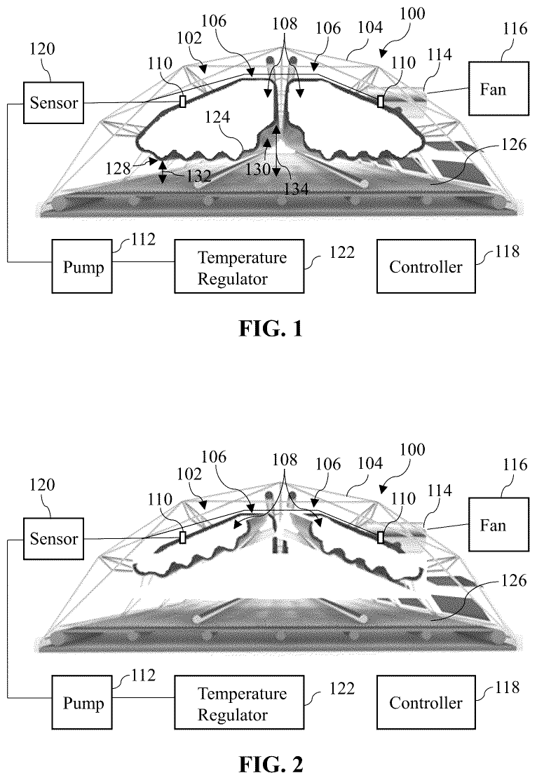

Those and other aspects of the invention are shown in FIGS. 1 and 2 and are discussed further as follows.

FIGS. 1 and 2 show a schematic view of a system 100 for partially filling an interior 102 of an enclosure 104 according to some aspects of the invention. The system 100 includes a bladder 106. Unless explicitly indicated to the contrary, the system 100 can include any number of components and reference to a singular component in the description does not necessarily limit the system to only one of the particular components. For example, the system 100 can include one bladder 106, two bladders 106, or more.

The bladder 106 can be flexible and can define an interior 108. The interior 108 can retain a fluid (e.g., air). The bladder 106 can include an inlet 110 that can fluidly connect the interior 108 of the bladder 106 to an external environment surrounding the bladder 106. In embodiments, the external environment can be external to both the interior 108 of the bladder 106 and the interior 102 of the enclosure 104. In embodiments, the external environment to the interior 108 of the bladder 106 can include the interior 102 of the enclosure 104.

The bladder 106 can be inflated (e.g., within the interior 102 of the enclosure 104) from a deflated configuration (FIG. 2) to an inflated configuration (FIG. 1) to fill a portion of the interior 102 of the enclosure 104. Filling the portion of the interior 102 of the enclosure with the inflated bladder 106 can have a number of advantages including any of the advantages previously described. For example, filling the portion of the interior 102 of the enclosure with the inflated bladder 106 can reduce the volume of air within the enclosure 104 that requires conditioning (e.g., circulation, cooling, heating, ventilation, etc.), which can save energy. In embodiments, the bladder 106 can reduce the volume of air within the enclosure 104 by between 40% and 60%, though over volumes outside this range are possible. The system 100 can be deployed and retracted quickly and the shape/design can be optimized (e.g., using fluid dynamic analysis) for efficient air exchange. The system 100 can be light weight, manufactured at low costs, and can have lifespan between 20 to 25 years. Additionally, the system 100 can provide corridors for daily activities and can include printed materials such as materials to simulate canopy, which favors wellbeing of birds. The system 100 itself can be efficient. For example, in embodiments the interior 108 of the bladder 106 can be inflated to pressures only slightly greater than the pressure within the interior 102 of the enclosure 104. For example, in embodiments the interior 108 of the bladder 106 can be inflated to a pressure between 2-8 PSI greater than the pressure within the interior 102 of the enclosure 104, though other pressure outside this range are possible.

The bladder 106 can be substantially fluid-tight to resist leaking of the fluid from the interior 108 of the bladder 106. In embodiments, the bladder 106 can include a membrane. The bladder 106 can be formed of a number of materials such as for example nylon, fiberglass, polyester, silicon, rubber, combinations thereof, among other possibilities. In embodiments, the bladder 106 can include a coating. For example, the coating can be a vinyl coating, a PVC coating, combinations thereof, among other possibilities. The bladder 106 can be decorative, for example, to simulate greenery for livestock.

The fluid that inflates the bladder 106 can be a gas or a liquid, or combinations thereof. In embodiments, the fluid that inflates the bladder 106 can be air and/or the same fluid as the fluid (e.g., air) that fills the enclosure 104. Alternatively, the fluid that inflates that bladder 106 can be a gas other than air and/or a different fluid than the fluid (e.g., air) that fills the enclosure 104. For example, in some embodiments the bladder 106 can be filled with a fluid with good heat retention properties, such as argon, which can help to regulate the temperature within the interior 102 of the enclosure 104.

The system 100 can include a pump 112. The pump 112 can be fluidly connected to the inlet 110 and can pump the fluid from the external environment and through the inlet 110 of the bladder 106 to inflate the interior 108 of the bladder 106.

The system 100 can include the enclosure 104. The enclosure 104 can include a vent 114 that can vent a gas (e.g., air) from the interior 102 of the enclosure 104 to an exterior environment surrounding the enclosure 104. The system 100 can include a fan 116, or functional equivalent, that can circulate air into/out of the interior 102 of the enclosure 104. In embodiments, the fan 116 can be a component of a larger climate control system for the enclosure 104 such as a heater or air conditioning system.

As described previously, the enclosure 104 can be for any number of uses. For example, the enclosure 104 can be for livestock (e.g., broiler chickens), a warehouse, or any other structure. The enclosure 104 can include a roof, a floor, and any number of walls and openings.

In embodiments, the bladder 106, when inflated, can occupy a portion of the interior 102 of the enclosure 104. The portion can be, for example, between 40% and 60% of the volume of the interior 102 of the enclosure 104.

In embodiments, the portion of the interior 102 of the enclosure 104 can define a first shape (e.g., concave shape, square shape, rectangular shape, triangular shape, an irregular shape, among other possibilities) and a first size. The bladder 106, when inflated, can define a second shape (e.g., concave shape, square shape, rectangular shape, triangular shape, an irregular shape, among other possibilities) and a second size. In embodiments, the second shape can substantially correspond to at least part of the first shape and can have a size smaller than the first size to nest within the first shape of the interior 102 of the enclosure 104 and occupy a volume within the first shape.

The system 100 can include a controller 118. The controller 118 can be operatively connected any number of controllable components of the system 100. For example, the controller 118 can be operatively connected to the pump 112 and can control the pump 112 to fill the bladder 106 with the fluid.

The system 100 can include a sensor 120. The sensor 120 can sense at least one of a pressure or a temperature within the interior of the bladder 106. In embodiments, the sensor 120 can be a pressure sensor. In embodiments, the sensor 120 can be a temperature sensor. The sensor 120 can be wholly or partially connected to the interior 108 of the bladder 106 to directly sense conditions within the interior 108. The sensor 120 can be connected to supply lines leading to the inlet 110 of the bladder 106 and can sense conditions within the supply lines to indirectly infer conditions (e.g., temperature or pressure) within the interior 108 of the of the bladder 106. In embodiments, the sensor 120 can be provided within the interior 108 of the bladder 106 to directly sense conditions (e.g., temperature or pressure) within the interior 108 of the of the bladder 106.

The controller 118 can be operatively connected to the sensor 120 and can control other components of the system 100 in response to feedback from the sensor 120. For example, the sensor 120 can directly or indirectly sense the pressure within the interior 108 of the bladder 106. The controller 118 can be operatively connected to the sensor 120 and can automatically control the pump 112 to maintain a predetermined pressure within the interior 108 of the bladder 106 based upon feedback of the pressure sensed by the sensor 120.

In embodiments, the system 100 can include a temperature regulator 122. The temperature regulator 122 can be, for example, a heater, a cooler, a heat pump, and air conditioner, combinations thereof, among other possibilities. In embodiments, the sensor 120 can sense the temperature within the interior 108 of the bladder 106 and the controller 118 can be operatively connected to the sensor 120 and to the temperature regulator 122. The controller 118 can automatically control the temperature regulator 122 to maintain a predetermined temperature within the interior 108 of the bladder 106 based upon feedback of the temperature sensed by the sensor 120.

In embodiments, when the bladder 106 is inflated to the inflated configuration within the interior 102 of the enclosure 104, a surface 124 of the bladder 106 that faces a floor 126 of the enclosure 104 can include a plurality of contours, such as for example first contours 128 and second contours 130. The plurality of contours can have any number regular or irregular shapes including concave, convex, among other possibilities.

In embodiments, the first contours 128 can be spaced from the floor 126 by a first distance 132 and the second contours 130 can be spaced from the floor 126 by a second distance 134. In embodiments such as shown in FIG. 1, the first contours 128 can be provided at the sides of the enclosure 104 and the second contours 130 can be provided at a center of the enclosure 104. The second distance 134 can be greater than the first distance 132. This configuration can be advantageous when the space between the respective contours and the floor 126 are utilized for different purposes. For example, the first distance 132 can be set to accommodate small livestock (e.g., chickens) that may prefer residing under a lower ceiling that simulates a canopy. The second distance 134 can be set to accommodate, for example, a human operator tending the livestock to provide the operator with more room to move within the enclosure 104.

It will be appreciated that the foregoing description provides examples of the invention. However, it is contemplated that other implementations of the invention may differ in detail from the foregoing examples. All references to the invention or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

What is claimed is:

1. A system for filling a portion of an interior of an enclosure, the system comprising:
a bladder that is flexible, the bladder defining an interior that is configured to retain a fluid, the bladder comprising an inlet that is configured to fluidly connect the interior of the bladder to an external environment surrounding the bladder,
wherein the bladder is configured to be inflated, within the interior of the enclosure, by the fluid from a deflated configuration to an inflated configuration to fill the portion of the interior of the enclosure.

2. The system of claim 1, further comprising a pump fluidly connected to the inlet, the pump is configured to pump the fluid from the external environment and through the inlet of the bladder to inflate the interior of the bladder.

3. The system of claim 2, further comprising a controller operatively connected to the pump,
wherein the controller is operatively connected to the pump and is configured to control the pump to fill the bladder with the fluid.

4. The system of claim 3, further comprising a sensor that is configured to sense a pressure within the interior of the bladder, and
the controller is operatively connected to the sensor and is configured to automatically control the pump to maintain a predetermined pressure within the interior of the bladder based upon feedback of the pressure sensed by the sensor.

5. The system of claim 3, further comprising a temperature regulator that is fluidly connected to the pump and that is configured to at least one of heat or cool the fluid pumped by the pump.

6. The system of claim 5, further comprising a sensor that is configured to sense a temperature within the interior of the bladder, wherein:
the controller is operatively connected to the sensor and to the temperature regulator, and
the controller is configured to automatically control the temperature regulator to maintain a predetermined temperature within the interior of the bladder based upon feedback of the temperature sensed by the sensor.

7. The system of claim 1, further comprising the enclosure.

8. The system of claim 7, wherein:
the portion of the interior of the enclosure defines a first shape and a first size,
the bladder in the inflated configuration defines a second shape and a second size, and
the second shape substantially corresponds to the first shape and the second size is smaller than the first size.

9. The system of claim 1, wherein the enclosure comprises a vent that is configured to vent a gas from the interior of the enclosure.

10. The system of claim 9, further comprising a fan that actively vents the gas from the interior of the enclosure through the vent.

11. The system of claim 1, wherein the enclosure is configured to contain livestock.

12. The system of claim 1, wherein the portion of the interior of the enclosure is between 40% and 60% of a volume of the interior of the enclosure.

13. The system of claim 1, wherein the bladder is substantially fluid-tight to resist leaking of the fluid from the interior of the bladder.

14. The system of claim 1, wherein the fluid is air.

15. The system of claim 1, wherein the fluid comprises a gas that is the same as a gas that fills the interior of the enclosure surrounding the bladder.

16. The system of claim 1, wherein the fluid comprises a gas that is different than a gas that fills the interior of the enclosure surrounding the bladder.

17. The system of claim 1, wherein the bladder comprises at least one of nylon, fiberglass polyester, or silicon.

18. The system of claim 17, wherein:
the bladder comprises a coating, and
the coating comprises at least one of polyester, PVC, or vinyl.

19. The system of claim 1, wherein a surface of the bladder that faces a floor of the enclosure, when the bladder is in the inflated configuration within the interior of the enclosure, comprises first contours and second contours.

20. The system of claim 19, wherein the first contours are spaced from the floor by a first distance and the second contours are spaced from the floor by a second distance, the second distance is greater than the first distance.
